(19) United States
(12) Patent Application Publication
(10) Pub. No.: US 2018/0203228 A1
(43) Pub. Date: Jul. 19, 2018

(54) HEAD-UP DISPLAY DEVICE

(71) Applicant: NIPPON SEIKI CO., LTD., Niigata (JP)

(72) Inventor: Takayuki HATANO, Niigata (JP)

(21) Appl. No.: 15/744,518

(22) PCT Filed: Jul. 12, 2016
(86) PCT No.: PCT/JP2016/070502

§ 371 Date: Jan. 12, 2018

(30) Foreign Application Priority Data
Jul. 28, 2015 (JP) 2015-148509

(51) Int. Cl. G02B 27/01; B60K 37/02

(52) U.S. Cl. CPC G02B 27/0101; G02B 2027/0118; B60K 37/02

(57) ABSTRACT

Provided is a head-up display device which reduces a sense of discomfort imparted to a viewer due to wearing polarized sunglasses. The head-up display device irradiates a front glass with display light containing, at a predetermined ratio, an s-polarized light component and a p-polarized light component associated with a reflective surface of the front glass. The head-up display device is provided with: a display that emits non-polarized light; and a light polarizing member that transmits, of the non-polarized light, the p-polarized light component more than the s-polarized light component such that the p-polarized light component of the display light reflected by the front glass approximates to the p-polarized light component of natural light having passed through the front glass.

### TECHNICAL FIELD

The present invention relates to a head-up display device.

### BACKGROUND ART

A conventional head-up display device enlarges display light emitted from a display using a concave mirror and irradiates a front glass with the enlarged display light as disclosed in, for example, PTL 1. A viewer can visually recognize a virtual image in the display light superimposed on the background seen through the front glass by receiving the display light reflected by the front glass.

### CITATION LIST

### Patent Literature

PTL 1: JP-A-2006-91489

### SUMMARY OF INVENTION

### Technical Problem

The head-up display device described in PTL 1 has a liquid crystal display element as a display. The display light from this liquid crystal display element is set to include an s-polarized light component more than a p-polarized light component to increase the reflectivity on the front glass. Polarized sunglasses have the function of blocking the s-polarized light component of display light. Therefore, when the viewer wears the polarized sunglasses, the brightness (display brightness) of the display light is significantly reduced when display light passes through the polarized sunglasses. Accordingly, how a virtual image is seen greatly depends on whether the viewer wears the polarized sunglasses, so a sense of discomfort may be imparted to the viewer.

There is proposed a display in which, for example, a DMD (Digital Micromirror Device) element is used instead of a liquid crystal display element. Generally, a display including a DMD element emits substantially unpolarized display light. Although the reflectivity of the p-polarized light component corresponding to the transmission axis of polarized sunglasses on the front glass is smaller than the reflectivity of the s-polarized light component, the display light reflected by the front glass includes the p-polarized light component. Accordingly, adoption of a display including a DMD element makes reduction in the display brightness due to use of polarized sunglasses smaller than in a display including a liquid crystal display element.

However, reduction in the display brightness due to use of polarized sunglasses is still not small and, in particular, the balance between reduction in the display brightness and reduction in the background brightness is lost when polarized sunglasses are used. Specifically, since natural light corresponding to the background brightness is not polarized, natural light includes a higher ratio of p-polarized light component than the display light reflected by front glass. Accordingly, the ratio of the display brightness when the polarized sunglasses are worn to the display brightness when the polarized sunglasses are not worn becomes larger than the ratio of the background brightness. Since the viewer visually recognizes the display superimposed on the background, if the balance between reduction in the background brightness and reduction in the display brightness is lost, a sense of discomfort may be imparted to the viewer. This problem may occur not only in a display including a DMD element, but also in a display including a self-luminous element such as an LED (Light Emitting Diode) or a VFD (Vacuum. Fluorescent Display).

The invention addresses the actual situation described above with an object of providing a head-up display device that reduces a sense of discomfort imparted to a viewer when the viewer wears polarized sunglasses.

### Solution to Problem

To achieve the above object, according to the invention, there is provided a head-up display device irradiating a glass with display light containing, at a predetermined ratio, a p-polarized light component and an s-polarized light component associated with a reflective surface of the glass, the head-up display device including a display that emits non-polarized light and a light polarizing member through which the p-polarized light component more than the s-polarized light component of the non-polarized light passes so that the p-polarized light component of the display light reflected by the glass approximates to the p-polarized light component of natural light having passed through the glass.

### Advantageous Effects of Invention

According to the invention, it is possible to reduce a sense of discomfort imparted to a viewer when the viewer wears polarized sunglasses.

### BRIEF DESCRIPTION OF DRAWINGS

FIG. 1 is a schematic view illustrating a vehicle in which a head-up display device according to a first embodiment of the invention is installed.

FIG. 2 is a schematic view illustrating the structure of the head-up display device according to the first embodiment of the invention and the incident angle of display light on a front glass.

FIG. 3 is a perspective view illustrating a display and a light polarizing member according to the first embodiment of the invention.

FIG. 4 illustrates the ratios of the background brightness and the display brightness when polarized sunglasses are worn according to the first embodiment of the invention.

### DESCRIPTION OF EMBODIMENTS

### First Embodiment

A head-up display device according to the first embodiment of the invention will be described with reference to FIGS. 1 to 4.

A head-up display device 10 according to the embodiment is installed in, for example, the dashboard of a vehicle 200 as illustrated in FIG. 1. The head-up display device 10 emits display light L for representing an image toward a front glass 201 of the vehicle 200. A viewer 1 (mainly, the driver of the vehicle 200) can visually recognize a virtual image V superimposed on the background seen through the front glass 201 by receiving the display light L reflected by the front glass 201.

### (Structure of the Head-Up Display Device 10)

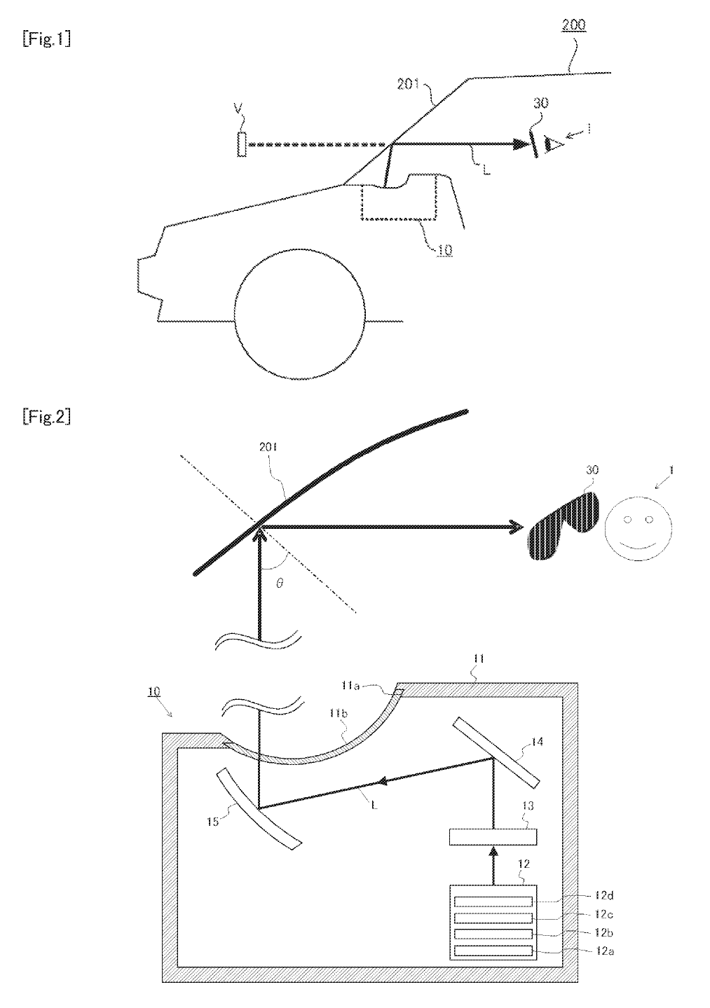

Specifically, the head-up display device 10 includes a case 11, a display 12, a light polarizing member 13, a fold-back mirror 14, and a concave mirror 15 as illustrated in FIG. 2.

The case 11 is a substantially rectangular parallelepiped having a hollow structure and made of a non-translucent resin material or a metal material. An opening 11a penetrating through the case 11 in the thickness direction thereof is formed in the position in the case 11 that faces the front glass 201. The opening 11a is inset with a translucent member 11b, formed in a curved plate, that is made of a translucent resin member such as acrylic through which the display light L passes. Components of the head-up display device 10 are housed in the case 11.

The display 12 emits the display light L representing a predetermined image under control of a control unit (not illustrated). Specifically, the display 12 includes a back light 12a for emitting light, a DMD element 12b for generating the display light L representing the predetermined image based on light from the back light 12a, a projection lens 12c for enlarging the display light L generated by the DMD element 12b, and a screen 12d on which the display light L from the projection lens 12c is projected. Unlike a display having liquid crystal display elements, the display 12 does not have a polarizing plate. Accordingly, the display light L emitted from the display 12 is substantially unpolarized.

The light polarizing member 13 is a polarizing plate installed in the optical path of the display light L from the display 12 and has the function of changing the display light L in a substantially unpolarized state to have a predetermined polarized state. The light polarizing member 13 will be described in detail later.

The fold-back mirror 14 is a planar reflecting mirror. The fold-back mirror 14 is installed at an angle of 45 degrees with respect to the display light L from the display 12 that has passed through the light polarizing member 13 and reflects the display light L toward the concave mirror 15.

The concave mirror 15 reflects the display light L toward the front glass 201. The concave mirror 15 reflects the display light L while enlarging it.

### (Structure and Working of the Front Glass)

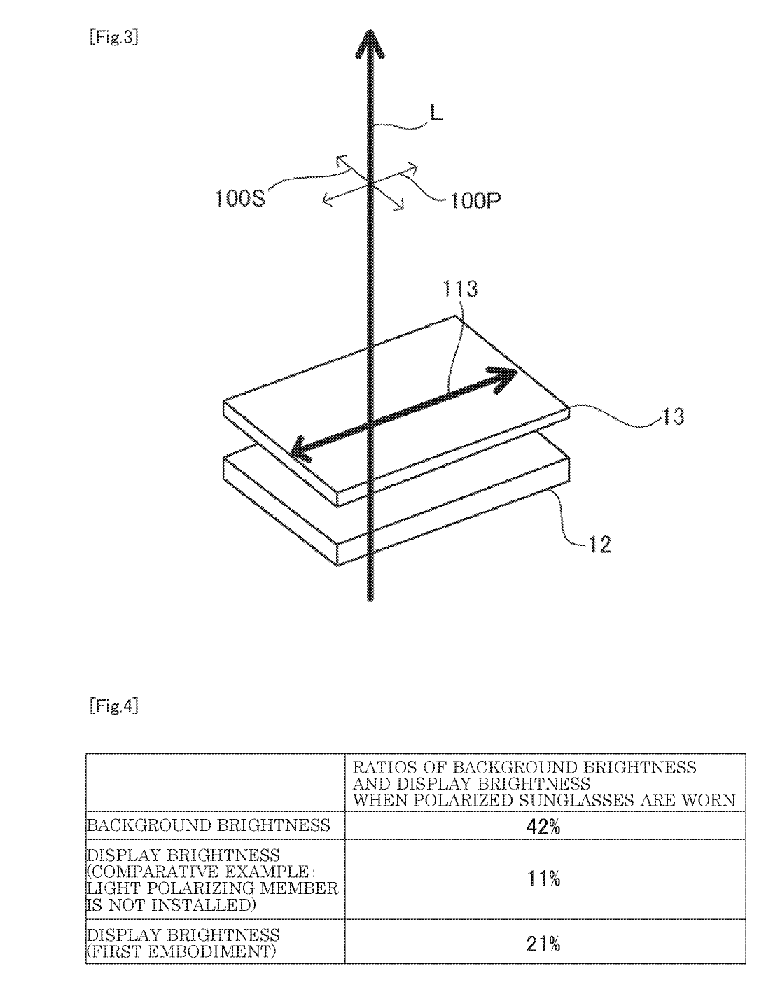

The front glass 201 reflects the display light L toward the viewer 1, as illustrated in FIG. 2. When the front glass 201 is assumed to be a reflective surface, the display light L can be separated into an s-polarized light component that vibrates along an s-polarization axis 100S with respect to the front glass 201 and a p-polarized light component that vibrates along a p-polarization axis 100P with respect to the front glass 201, as illustrated in FIG. 3. The s-polarization axis 100S and the p-polarization axis 100P are orthogonal to each other. The reflectivity of the s-polarized light component and the reflectivity of the p-polarized light component depend on an incident angle θ of the display light L on the front glass 201. The incident angle θ is formed by the display light L and the normal line of the front glass 201, as illustrated in FIG. 2. The relationship between the incident angle θ and the reflectivity is calculated based on Fresnel's reflection law. Generally, although the incident angle θ of the display light L on the front glass 201 depends on the type of a vehicle, it ranges from 50 degrees to 75 degrees in general. In this example, the incident angle θ of the display light L on the front glass 201 is 70 degrees.

As is clear from Fresnel's reflection law, the reflectivity of the p-polarized light component greatly depends on the incident angle θ. For example, when the refraction index of the front glass 201 is approximately 1.5, Brewster's angle is given when the incident angle θ is 57 degrees. The incident angle θ of the display light L on the front glass 201 is close to Brewster's angle. Accordingly, the reflectivity of the p-polarized light component is smaller than the reflectivity of the s-polarized light component. In this example, the reflectivity of the s-polarized light component on the front glass 201 is 41% and the reflectivity of the p-polarized light component on the front glass 201 is 7%.

It is assumed that the viewer 1 wears polarized sunglasses 30 when visually recognizing the virtual image V and the background. Generally, the polarized sunglasses 30 have the function of blocking the s-polarized light component of light because of its character. In this example, in the polarized sunglasses 30, the natural light transmission factor is 33%, the polarization degree is 95%, the transmission factor of the transmission axis of the polarized sunglasses 30 is 64%, and the transmission factor of the non-transmission axis is 1.7%.

### (Structure and Function of the Light Polarizing Member 13)

Since the reflectivity of the p-polarized light component on the front glass 201 is small as described above, the p-polarized light component in the display light L reflected by the front glass 201 is generally apt to become smaller than the s-polarized light component. Accordingly, in the conventional structure, the difference between the p-polarized light component of the display light L reflected by the front glass 201 and the p-polarized light component of natural light in the non-polarized state is apt to become large. The p-polarized light component more than the s-polarized light component passes through the light polarizing member 13 according to the embodiment so that the p-polarized light component of the display light L having reflected by the front glass 201 approximates to the p-polarized light component of natural light. Preferably, 75% or more of the p-polarized light component with respect to the front glass 201 passes through the light polarizing member 13 and 5% to 50% of the s-polarized light component with respect to the front glass 201 passes through the light polarizing member 13.

For example, the transmission factor of natural light for the light polarizing member 13 is 60% and the polarization degree is 45%. The light polarizing member 13 has a polarization transmission axis 113 as illustrated in FIG. 3. The polarization transmission axis 113 extends in parallel to the p-polarization axis 100p of the front glass 201 and orthogonally to the s-polarization axis 100S of the front glass 201.

(Reduction in Brightness when Polarized Sunglasses are Worn)

The table in FIG. 4 illustrates the ratios of the background brightness and the display brightness when the viewer 1 wears the polarized sunglasses 30 to the background brightness and the display brightness (assumed to be 100% as the reference) as seen from the viewer 1 when the viewer 1 does not wear the polarized sunglasses 30. This background brightness is determined based on the part of the natural light having passed through the front glass 201 from the outside of the vehicle. That is, since the light for determining the background brightness is the light having passed through the front glass 201, the ratio of the p-polarized light component in the light is higher than in simple natural light. Although the polarized sunglasses 30 having a natural light transmission factor of 33% is used and explained in this example, since the light for determining the background brightness includes a higher ratio of the p-polarized light component than natural light, the ratio of the background brightness when the polarized sunglasses 30 are worn to the background brightness when the polarized sunglasses 30 are not worn is 42% (which is larger than the natural light transmission factor 33% of the polarized sunglasses 30) in the embodiment. On the other hand, the display brightness is determined based on the display light L reflected by the front glass 201. In the case (as a comparative example) in which the light polarizing member 13 of the embodiment is not installed, the ratio of the display brightness when the polarized sunglasses 30 are worn to the display brightness when the polarized sunglasses 30 are not worn is 11%. In the comparative example, the ratio (11%) of the display brightness when the polarized sunglasses 30 are worn divided by the ratio (42%) of the background brightness when the polarized sunglasses 30 are worn is approximately 0.26. In contrast, in the embodiment, the ratio of the display brightness when the polarized sunglasses 30 are worn to the display brightness when the polarized sunglasses 30 are not worn can remain at 21%. That is, in the embodiment, the ratio (21%) of the display brightness when the polarized sunglasses 30 are worn divided by the ratio (42%) of the background brightness when the polarized sunglasses 30 are worn is approximately 0.50. This ratio preferably ranges from 0.5 to 1 to reduce a sense of discomfort imparted to the viewer 1 when the viewer 1 wears the polarized sunglasses 30.

### (Effects)

According to the first embodiment described above, the following effects can be obtained.

(1) The head-up display device 10 irradiates the front glass 201 with the display light L containing, at a predetermined ratio, the p-polarized light component and the s-polarized light component associated with the reflective surface of the front glass 201. The head-up display device 10 includes the display 12 that emits non-polarized light and the light polarizing member 13 through which the p-polarized light component more than the s-polarized light component of the non-polarized light from the display 12 passes so that the p-polarized light component of the display light L reflected by the front glass 201 approximates to the p-polarized light component of natural light passed through the front glass 201.

In this structure, the p-polarized light component of the display light L irradiating the viewer 1 can be increased. The transmission factor of the p-polarized light component in the polarized sunglasses 30 is sufficiently larger than in the s-polarized light component. Accordingly, the ratio of the display brightness when the polarized sunglasses 30 are worn to the case in which the polarized sunglasses 30 are not worn can approximate to the ratio of the background brightness when the polarized sunglasses 30 are worn. This can improve the balance between reduction in the background brightness and reduction in the display brightness when the polarized sunglasses 30 are worn, thereby reducing a sense of discomfort imparted to the viewer 1.

(2) 75% or more of the p-polarized light component of the non-polarized light from the display 12 passes through the light polarizing member 13 and 5% to 50% of the s-polarized light component of the non-polarized light from the display 12 passes through the light polarizing member 13. In this structure, the s-polarized light component is mixed with the display light L that irradiates the viewer 1. Since this s-polarized light component is substantially fully blocked by the polarized sunglasses 30, the display brightness can be reduced moderately when the polarized sunglasses 30 are worn. For example, if the display brightness is not reduced at all even when the polarized sunglasses are worn, a sense of discomfort is imparted to the viewer 1 due to the relationship with the background brightness. In contrast, since the display brightness can be reduced when the polarized sunglasses 30 are worn in the embodiment, a sense of discomfort imparted to the viewer 1 can be reduced.

(3) Light from the display 12 passes through the light polarizing member 13 so that the ratio of the brightness (display brightness) of the display light L as seen from the viewer 1 when the polarized sunglasses 30 are worn to the case in which the polarized sunglasses 30 are not worn divided by the ratio of the brightness (background brightness) of natural light as seen from the viewer 1 when the polarized sunglasses 30 are worn to the case in which the polarized sunglasses 30 are not worn ranges from 0.5 to 1 (approximately 0.50 in this embodiment). In this structure, the balance between reduction in the background brightness and reduction in the display brightness when the polarized sunglasses 30 are worn can be set so that a large sense of discomfort is not imparted to the viewer 1.

### Second Embodiment

In the second embodiment, the light polarizing member 13 is set so that the ratio of the background brightness when the polarized sunglasses 30 are worn to the case in which the polarized sunglasses 30 are not worn is the same as the ratio of the display brightness when the polarized sunglasses 30 are worn to the case in which the polarized sunglasses 30 are not worn. In the embodiment, the head-up display device 10 has the same structure as in the first embodiment except conditions such as the polarization degree of the light polarizing member 13.

### (Description of Computational Expressions)

Specifically, a polarization degree P is generally calculated by expression (1) below.

Polarization degree P=((H0−H90)/(H0+H90))½ (1)

In expression (1) above, parallel Nicol transmission factor H0 and crossed Nicol transmission factor H90 are introduced by expressions (2) and (3) below.

H0=0.5*(K1²+K2²) (2)

H90=K1*K2 (3)

Where K1 is the polarization transmission factor in the transmission axis direction and K2 is the polarization transmission factor in the non-transmission axis direction.

In addition, natural light transmission factor Y is calculated by expression (4) below.

Y=(K1+K2)/2 (4)

### (Conditions of the Polarized Sunglasses 30 and the Light Polarizing Member 13)

First, conditions of the polarized sunglasses 30 in the embodiment will be described.

When K1=0.6379 and K2=0.0174 in the polarized sunglasses 30, the natural light transmission factor Y is 0.3277 (32.77%) based on expression (4) above. In the light having passed through the front glass 201, which determines the background brightness, the ratio of the p-polarized light component is high as described above. Specifically, when the front glass 201 is inclined so that the incident angle θ of the display light L is 70 degrees, the refraction index is 1.5, and the internal transmission factor is 0.85, then the ratio of the p-polarized light component to the intensity of the light having passed through the front glass 201 is 0.6419 (64%). In this case, the ratio of the background brightness when the polarized sunglasses 30 are worn to the case in which the polarized sunglasses 30 are not worn is 42%.

Next, conditions of the light polarizing member 13 in the embodiment will be described. It should be noted that the polarization transmission factor K1 in the transmission axis direction is the transmission factor in the polarization transmission axis 113 of the light polarizing member 13. The polarization transmission factor K2 in the non-transmission axis direction is the transmission factor in the direction orthogonal to the polarization transmission axis 113 of the light polarizing member 13.

When K1=0.9000 and K2=0.0842 in the light polarizing member 13, H0=0.4085 and H90=0.0758 are calculated based on the expressions (2) and (3) above and the polarization degree P=0.8289 is calculated based on the expression (1) above. That is, the polarization degree of the light polarizing member 13 is set to approximately 0.8 by rounding off to one decimal place.

When the incident angle θ of the display light L on the front glass 201 is 70 degrees and the polarization degree P of the light polarizing member 13 is 0.8289 (approximately 0.8 by rounding off to one decimal place), the ratio of the display brightness when the polarized sunglasses 30 are worn to the case in which the polarized sunglasses 30 are not worn is calculated to 0.41549 (approximately 42%). Accordingly, the ratio of the brightness when the polarized sunglasses 30 are worn to the case in which the polarized sunglasses 30 are not worn can be set to the same value between the background brightness and the display brightness.

### (Effects)

According to the second embodiment described above, the following effects can be obtained particularly.

(4) The incident angle of the display light L on the front glass 201 is 70 degrees and the polarization degree of the light polarizing member 13 is set to approximately 0.8. Accordingly, the ratio of the display brightness when the polarized sunglasses 30 are worn to the case in which the polarized sunglasses 30 are not worn and the ratio of the background brightness when the polarized sunglasses 30 are worn to the case in which the polarized sunglasses 30 are not worn can be set to the same value. This further suppresses changes in the balance between the background brightness and the display brightness when the polarized sunglasses 30 are worn, thereby minimizing a sense of discomfort imparted to the viewer 1.

### (Modification)

The above embodiments can be practiced as the following modes obtained by modifying them.

Although the display 12 has the DMD element 12b in the above embodiments, the display may have a self-luminous element such as an LED or a VFD.

Although 75% or more of the p-polarized light component passes through the light polarizing member 13 and 5% to 50% of the s-polarized light component passes through the light polarizing member 13 in the first embodiment, the transmission factors of the p-polarized light component and the s-polarized light component may be changed as long as a sense of discomfort is imparted to the viewer 1 when the viewer 1 wears the polarized sunglasses 30. For example, the light polarizing member 13 may completely block the s-polarized light component.

Although the ratio of the display brightness divided by the ratio of background brightness when the polarized sunglasses 30 are worn to the case in which the polarized sunglasses 30 are not worn is equal to approximately 0.50, which falls within the range from 0.5 to 1 in the first embodiment, this ratio may be set to a value that falls outside the range from 0.5 to 1 as long as a large sense of discomfort is not imparted to the viewer 1 when the polarized sunglasses 30 are worn.

Although the light polarizing member 13 is provided separately from the display 12 in the first and second embodiments, the light polarizing member 13 may be provided as a part of the display 12.

Although the head-up display device 10 projects the display light L to the front glass 201 in the first and second embodiments, the head-up display device 10 may project the display light L to a glass other than the front glass 201.

Although the head-up display device 10 is installed in a vehicle in the first and second embodiments, the head-up display device 10 may be installed in a carriage such as an airplane or ship in addition to a vehicle.

### INDUSTRIAL APPLICABILITY

The invention is useful to a head-up display device that has the effect of reducing a sense of discomfort imparted to a viewer when wearing polarized sunglasses and visually recognizes an image outdoor.

### REFERENCE SIGNS LIST

1: viewer
10: head-up display device
11: case
12: display
12a: back light
12b: DMD element
12c: projection lens
12d: screen
13: light polarizing member
14: fold-back mirror
15: concave mirror
130: polarized sunglasses
100S: s-polarization axis
100P: p-polarization axis
113: polarization transmission axis
200: vehicle
201: front glass (glass)

1. A head-up display device irradiating a glass with display light containing, at a predetermined ratio, a p-polarized light component and an s-polarized light component associated with a reflective surface of the glass, the head-up display device comprising:
a display that emits non-polarized light; and
a light polarizing member through which the p-polarized light component more than the s-polarized light component of the non-polarized light passes so that the p-polarized light component of the display light reflected by the glass approximates to the p-polarized light component of natural light having passed through the glass.

2. The head-up display device according to claim 1,
wherein 75% or more of the p-polarized light component of the non-polarized light passes through and 5% to 50% of the s-polarized light component of the non-polarized light passes through the light polarizing member.

3. The head-up display device according to claim 1,
wherein the non-polarized light passes through the light polarizing member so that a ratio of brightness of the display light seen from a viewer when polarized sunglasses are worn to a case in which the polarized sunglasses are not worn divided by a ratio of brightness of natural light seen from the viewer when the polarized sunglasses are worn to a case in which the polarized sunglasses are not worn ranges from 0.5 to 1.

4. The head-up display device according to claim 1,
wherein an incident angle of the display light on the glass is 70 degrees and a polarization degree of the light polarizing member is set to approximately 0.8.

5. The head-up display device according to claim 2,
wherein the non-polarized light passes through the light polarizing member so that a ratio of brightness of the display light seen from a viewer when polarized sunglasses are worn to a case in which the polarized sunglasses are not worn divided by a ratio of brightness of natural light seen from the viewer when the polarized sunglasses are worn to a case in which the polarized sunglasses are not worn ranges from 0.5 to 1.

6. The head-up display device according to claim 2,
wherein an incident angle of the display light on the glass is 70 degrees and a polarization degree of the light polarizing member is set to approximately 0.8.

7. The head-up display device according to claim 3,
wherein an incident angle of the display light on the glass is 70 degrees and a polarization degree of the light polarizing member is set to approximately 0.8.
